(19) United States
(12) Patent Application Publication
(10) Pub. No.: US 2014/0040111 A1
(43) Pub. Date: Feb. 6, 2014

(54) SYSTEMS AND METHODS FOR ANALYZING LOAN ACQUISITIONS

(71) Applicants: CHRISTOS BETTIOS, Newport Beach, CA (US); Laura Anne Roedel, Huntington Beach, CA (US); Patrick Edward McLaughlin, Santa Ana, CA (US); Robert Anthony Camerota, Chino, CA (US)

(72) Inventors: CHRISTOS BETTIOS, Newport Beach, CA (US); Laura Anne Roedel, Huntington Beach, CA (US); Patrick Edward McLaughlin, Santa Ana, CA (US); Robert Anthony Camerota, Chino, CA (US)

(21) Appl. No.: 13/563,591

(22) Filed: Jul. 31, 2012

(51) Int. Cl. G06Q 40/02

(52) U.S. Cl. 705/38

(57) ABSTRACT

Various embodiments provide for systems and methods for analyzing loan acquisitions by: receiving a loan closing dataset relating to a loan (e.g., through an industry HUD-1 data portal); generating a set of interim analysis results from the loan closing dataset by extracting information from the loan closing dataset (e.g., the HUD-1 form associated with the loan); generating a set of analysis results by evaluating the set of interim analysis results according to a set of analysis rules (e.g., lender or investor rules); and generating a set of scores for the loan based on the set of analysis results. According to some embodiments, the set of analysis rules are configured to evaluate a transfer of interest in the loan (e.g., from a lender originating the loan to a party investing in the loan) for a set of investment risks, and the set of scores represent the set of investment risks.

### FIELD OF THE INVENTION(S)

The present invention(s) generally relate to loan analysis and, more particularly, relate to systems and methods for analyzing the acquisition of loans, such as in an investment context.

### DESCRIPTION OF THE RELATED ART

Lenders (also referred to as “lending parties”) often originate loans (e.g., mortgages) that they eventually sell to one or more investing parties (e.g., loan buyers and loan investors). To determine the potential risk, the return-on-investment, and likelihood of success of such loans, investing parties (hereafter referred to as “investors”) usually evaluate/assess the quality of the loans before purchase. Likewise, because the agreement typically utilized in the sale of such loans often includes a buy-back provision, whereby the loan selling party (e.g., lender) is obligated to repurchase the loan from the investor when the loan fails to meet certain conditions after the sale (e.g., fails to perform according to certain criteria set forth in the agreement).

Generally, the quality of a loan (e.g., risk of default or determining the return-on-investment) can be judged based on information provided in the loan documents and data generated when the loan is made, particularly the loan documents and data (“loan closing data”) generated during the settlement and closing process for the loan (hereafter referred to as the “loan closing process” or the “closing process”). The closing process often takes place after the loan from a lender to a lendee (i.e., borrowing party or loan recipient) has been approved, and is handled by a settlement/closing agent (hereafter referred to “closing agent”), who uses an escrow system (also known as a “closing system”) to capture (e.g., enter) escrow and funding data relating to the loan before the loan is closed (i.e., the loan is provided to the lendee).

As part of the data capture process involving a real estate loan, closing agents may enter loan escrow and funding information into the HUD-1 settlement form (also referred to as a “settlement statement,” “closing statement,” “settlement sheet,” but hereafter referred to as the “HUD-1 form” or “HUD-1”) provided by the U.S. Department of Housing and Urban Development. Closing agents generally use the HUD-1 form as a standard real estate settlement form, typically in transactions involving federally related mortgage loans, to itemize all charges imposed on a lendee and seller in a real estate transaction involving a real estate loan. During the loan closing process and before the loan closes, the lender and the closing agent handling the loan may review and revise the HUD-1 form and other loan documents multiple time (e.g., four to seven times) to ensure accuracy and compliance of the data being provided in the loan documents. While the initial version of the HUD-1 will be based on good-faith estimate (GFE) figures relating to the loan (generally provided by the lender), the final version of the HUD-1 form (i.e., the version at the time of the loan closing) will provide the final breakdown of the costs involved in providing the real estate loan, and will identify the parties who will be receiving the charges and fees associated with the real estate loan. In doing so, the HUD-1 form provides a general over of the loan closing process, and provides the lender, lendee, and closing agent with a complete list of incoming and outgoing funds.

### SUMMARY OF EMBODIMENTS

Various embodiments discussed herein provide systems and methods for analyzing loans and, more specifically, for assessing the quality of a loan before or after it is acquired in an investment context.

According to some embodiments, a method is provided for analyzing acquisition of loans (e.g., in investment contexts), comprising: receiving a loan closing dataset relating to a loan (e.g., through an industry HUD-1 data portal to accept data from lenders, closing agents, and the lender's other providers); generating a set of interim analysis results from the loan closing dataset by extracting information from the loan closing dataset (e.g., the HUD-1 form associated with the loan, or title information regarding the real estate related to the loan); evaluating the set of interim analysis results according to a set of analysis rules (e.g., lender or investor rules) to generate a set of analysis results, wherein the set of analysis rules are configured to evaluate a transfer of interest (e.g., ownership from a lender originating the loan to a party investing in the loan) in the loan for a set of investment risks; and generating a set of scores for the loan based on the set of analysis results, wherein the set of scores are representative of the set of investment risks. The method may further generate an overall score from the set of scores, thereby providing an overall grade of quality for the loan in question. Eventually, the set of analysis results, the set of scores, or both may be delivered to an interested-party (e.g., a stakeholder, such as a lender or an investor) through a generated report, possibly delivered in electronic form through a web-based portal or electronic mail (e-mail). Depending on the embodiment, the method may be performed before or after the loan has been purchased (i.e., transferred) from one party (e.g., lender) to another (e.g., loan buyer).

In some embodiments, the method further comprises validating the loan closing dataset before the set of interim analysis results is generated, thereby ensuring that the proper closing loan data is received and analyzed. The method may further comprise determining the set of rules to be utilized during evaluation of the set of interim analysis results. For instance, the set of rules utilized may be determined according to the party requesting the analysis (e.g., lender, investor, or closing agent).

The loan closing dataset analyzed may he received from a closing gent that is (or was) responsible for handling the closing process of the loan. For example, the loan closing dataset may he received from an escrow system utilized by the closing agent in handling the settlement of the loan. When receiving the closing loan data, some embodiments may utilize data interfaces in compliance with industry data standards, such as Mortgage Industry Standards Maintenance Organization (MISMO®).

For some embodiments, the loan closing dataset may comprise a HUD-1 settlement statement prepared in relation to the loan. The HUD-1 settlement statement may he a final version of the HUD-1 settlement statement prepared at or near a time when a closing process for the loan concludes. Additionally, where the loan closing dataset comprises a HUD-1 settlement form, generating a set of interim analysis results from the loan closing dataset may comprise gathering information from a predetermined set of fields in the HUD-1 settlement statement. The predetermined set of fields may include, for example, 201. Deposit or earnest money, 202. Principal amount of new loan(s), 203. Existing loan(s) taken subject, 303. Cash (X From) (To) Borrower, 303. Cash (From) (X To) Borrower, 401. Contract sales price, 703. Commission paid at settlement, or 803. Your adjusted origination charges from HUD-1 form (OMB Approval No. 2502-0265). The set of fields may be predetermined according to the analysis rules to be utilized during loan analysis. Additionally, the information gathered from the set of fields may be a numerical value, a Boolean value, or a text value, depending on the types of fields involved (e.g., where checkbox fields result in a Boolean value).

Those skilled in the art will appreciate that various embodiments may utilize different types of loan closing data in addition to, or in place of, the HUD-1 data discussed herein. For example, while the various embodiments described herein are done so in the context of using HUD-1 data, the loan closing dataset may comprise closing/settlement data from other types of settlement forms, including those provided by government agencies other than the U.S. Department of House and Urban Development (e.g., U.S. Consumer Financial Protection Bureau).

In some embodiments, generating a set of interim analysis results from the loan closing dataset may comprise calculating values based on the information according to the set of analysis rules. Further, in some embodiments, generating a set of interim analysis results from the loan closing dataset may comprise adjusting how, during generation of the set of analysis results, the set of interim analysis results is evaluated according to the set of analysis results. For instance, part of the interim analysis results may comprise a selective listing of rules from the set of analysis rules that should he used/applied during the evaluation of the interim analysis results.

The set of analysis rules may, for some embodiments, comprise logic for evaluating the interim analysis results according to a set of investment criteria and generating a set of evaluation results that become part of the analysis results. Depending on the embodiment, the set of investment criteria may he dynamically determined based on the preferences and settings of the party utilizing the system (e.g., a lender's profile or an investor's profile) or based on the type of loan being originated. Additionally, for various embodiments, the set of scores may be generated according to the set of analysis rules (e.g., where the set of analysis rules may comprise logic for scoring the loan based on the set of analysis results).

As part of analyzing the quality of the loan, the method may further comprise generating a loan acquisition issue list based on the set of scores or the analysis results. For example, if particular errors are detected during the analysis process (e.g., in the loan closing documents/data), or certain values fall outside of tolerable ranges, such issues may be flagged and provided in the loan acquisition issue list. For some embodiments, the loan acquisition issue list may be part of an overall report that provides detail findings and scores from the loan analysis.

Depending on the embodiments, the set of analysis rules may comprise a rule relating to a minimum borrower contribution, an excessive contribution from an interested party, a refinance cash-out limitation, a combined loan-to-value (CLTV) ratio check on a simultaneous second (e.g., lien or mortgage), a loan originator compensation, a potential for mortgage fraud, exceptional line activity, a regulation-specific high fee, line amount check and balance, or a third-party fee according to a regulation (e.g. the Home Owner's Equity Protection Act [HOEPA] Section 32, or some similar state regulation).

Where a given loan to be analyzed is associated with one or more other loans (e.g., where the loans are related to the same underlying property, lie a real property), the analysis of the given loan may involve analyzing the loan closing data for the given loan and each of the associated loans. The analysis of the given loan and the each of associated loans may be according to the analytical rules applied the given loan (e.g., where an analytical rule is configured to analyze associated, secondary loans).

According to some embodiments, various operations described herein are implemented in a system, possibly using a computer system. Some embodiments provide for a computer program product comprising a computer useable medium having computer program code embodied therein for analyzing a loan for the purpose of acquisition (e.g., as an investment) in accordance with aspects described herein.

Other features and aspects of some embodiments will become apparent from the following detailed description, taken in conjunction with the accompanying drawings, which illustrate, by way of example, the features in accordance with various embodiments.

### BRIEF DESCRIPTION OF THE DRAWINGS

Various embodiments are described in detail with reference to the following figures. The drawings are provided for purposes of illustration only and merely depict some example embodiments. These drawings are provided to facilitate the reader's understanding of the various embodiments and shall not be considered limiting of the breadth, scope, or applicability of embodiments.

FIG. 1 is diagram illustrating an exemplary environment in which various embodiments can be implemented.

FIG. 2 is diagram illustrating data interactions between a closing system, a lender closing system, a loan investment acquisition system, and a loan analysis system, in accordance with some embodiments, in an exemplary environment.

FIG. 3 is diagram illustrating an exemplary loan acquisition analysis system in accordance with some embodiments.

FIG. 4 is a diagram illustrating data interactions between a loan investment acquisition system, a lender investment system, a lender closing system, a closing system, and a loan acquisition analysis system, in an exemplary environment, in accordance with some embodiments.

FIG. 5 is flowchart illustrating an exemplary method for analyzing loan acquisitions in accordance with some embodiments.

FIG. 6 is an exemplary analysis report generated by some embodiments.

FIG. 7 is a diagram illustrating an exemplary computing system with which aspects of the systems and methods described herein can be implemented in accordance with various embodiments.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS

A number of embodiments described herein relate to systems and methods for analyzing loans and, particularly, for assessing the quality of a loan before or after it is acquired in an investment context. Embodiments may provide a centralized data repository of “trusted loan closing data” that can permit loan sellers, loan buyers and downstream loan investors to validate and assess loan investments, either pre-investment or post-investment. Additionally, embodiments may provide processes (e.g., on a centralized software or hardware platform) for evaluating loan closing data (e.g., at the time of the loan's closing), according to analytical rules (e.g., business rules), to assess the quality of the loan (e.g., for investment purposes).

Lenders or investors may utilize various embodiments to provide certainty in lending, or to monitor compliance of loans with investor-specific guidelines. Lenders may, for example, utilize such embodiments to evaluate all loans at closing using the final HUD1 data generated for the loans, and perform the evaluation according to a set of standardized/default rules, lender-specific rules, investor rules, or some combination thereof. Thereafter, the lender may provide the results of the evaluation (e.g., loan analysis, which may include scores), along with the final HUD-1 data for the loans, to potential investors.

Embodiments may assist a lender in determining the overall risk of selling a loan to an investor. In addition, in contexts where a loan is sold from a lender to an investor under buy-back provisions, increasing certainty in lending can minimize the risk of the seller (e.g., lender) having to repurchase the loan from an investor when the loan performance invokes the buy-back provision. Further, embodiments can reduce errors when parties (e.g., lenders or investors) are reviewing loan closing data, and can obviate the need for manual/spot-check review of HUD-1 data when assessing the quality of a loan.

Various embodiments may utilize industry data standards, such as MISMO® standards, when providing and receiving data. For example, some system embodiments may receive loan closing data in a data file format in compliance with the MISMO® data standard, and provide results of a loan analysis (e.g., scores or issue list) in data file format in compliance with the MISMO® data standard. Through use of the MISMO® data standard, certain embodiments may ensure industry-wide availability of the loan analysis tools described herein.

As noted herein, the loan closing data analyzed may comprise HUD-1 data, preferably the final version of the HUD-1 data prepared at the time of the loan's closing. By using the HUD-1 data of a loan to assess a loan's quality, embodiments are provided visibility/access to critical financial details of a real estate transaction involving a loan, and loan level pricing adjustments.

Depending on the party making use of the process and their particular relation to a loan (e.g., they are the lender, loan buyer, or downstream loan investor), various embodiments may utilized different sets of analytical rules when evaluating a loan. For instance, for a given investor, the rules applied may include those from standard for investors, and those from customized set prepared for or by the investor. Similarly, sets of rules may be specifically prepared for or by selling party (e.g., lender). The analytical rules may embody and apply industry best practices or investor-specific categories. Various embodiments may generate detailed findings as well as a confidence scores at a rule or category-level, and may prepare a formatted report or a structured data file listing such findings or confidence scores. The report or structured data file may include indicators, such as visual indicators (e.g., color indicators), to quickly communicate or flag quality issues to parties.

Access to the findings and scores may be facilitated through a web-based portal, whereby a lender or an investor, for example, is provided with a separate view for each loan being evaluated. Further, access to particular closing data, findings, and details through embodiments may be restricted or segregated according to parties. For example, the findings and scores generated by an embodiment for Loan A under a lender's specific rules may not be viewable by an investor having access to closing data for Loan A through the embodiment. Similarly, the findings and scores generated by the embodiment for Loan A under the investor's specific rules may not be viewable by the lender through the embodiment (despite the lender having ownership of the loan).

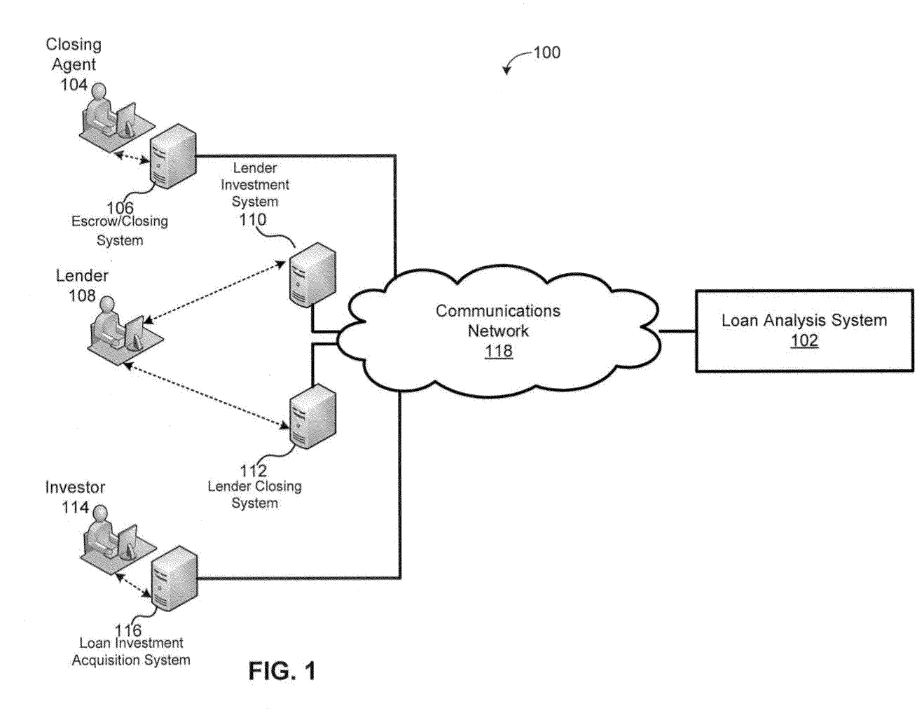

FIG. 1 is diagram illustrating an exemplary environment 100 in which various embodiments can be implemented. Referring now to FIG. 1, the environment 100 includes a loan analysis system 102, an escrow/closing system 106 (hereafter referred to as “closing system 106”), a lender investment system 110, a lender closing system 112, and a loan investment acquisition system 116. As illustrated, the loan analysis system 102, the closing system 106, the lender investment system 110, the lender closing system 112, and the loan investment acquisition system 116 may be communicatively coupled with each other through a computer network 118 (e.g., a wired or wireless network connection). Data interactions between the systems 102, 106, 110, 112, and 116 may be facilitated through one or more network systems contained within the computer network 118.

In some embodiments, the closing system 106 can (e.g., at the request of a lender 108) provide the loan analysis system 102 with loan closing data over the computer network 118, the lender investment system 110 can transmit a request to the loan analysis system 102 to analyze a loan according to specific analytical rules (e.g., according to lender-specific rules), the lender closing system 112 can (e.g., at the request of a lender 108) transmit an order to the closing system 106 to commence a loan closing process or generate loan closing data, and the loan investment acquisition system 116 can transmit a request to the loan analysis system 102 to analyze a loan according to specific analytical rules (e.g., according to investor-specific rules).

The closing agent 104 may employ the closing system 112 to receive requests to commence loan closing processes, perform loan closing processes, enter escrow and funding information, and submit loan closing data (e.g., HUD-1 data) to the loan analysis system 102. The lender investment system 110 can provide the lender 108 with the ability to create lender-specific analytical rules (e.g., through the loan analysis system 102), to view loan closing data (e.g., as provided by the loan analysis system 102 or the closing system 112), to review analysis results and score information generated in accordance with lender-specific analytical rules and provided by the loan analysis system 102, to enable an investor to access loan closing data stored on the loan analysis system 102, or request the sale or transfer of a loan to the investor 114. The lender closing system 112, on the other hand, may permit the lender 108 to request the commencement of a loan closing process (e.g., to the closing system 112), to request the generation of loan closing data (e.g., via the closing system 112), and to provide the closing agent 104 with loan information for loan closing processes (e.g., via the closing system 112). For certain embodiments, the lender investment system 110 and the lender closing system 112 may be part of a single lender system (not shown). The loan investment acquisition system 116 may permits an investor 114 to create investor-specific analytical rules (e.g., through the loan analysis system 102), to view loan closing data (e.g., as provided by the loan analysis system 102 or the closing system 112), to review analysis results and score information generated in accordance with investor-specific analytical rules and provided by the loan analysis system 102, or accept the sale or transfer of a loan to the investor 114.

According to some embodiments, the loan analysis system 102 may evaluate a loan, based on associated closing data (e.g., at the time of the loan's closing) and according to analytical rules (e.g., business rules), to assess the quality of the loan (e.g., for investment purposes) or check loan closing data for compliance. The loan analysis system 102 may utilized (e.g., by the closing agent 104 or the lender 108) as a compliance tool for loan data either pre-closing or post-closing of the loan. The loan analysis system 102 may also be utilized (e.g., by the lender 108 or the investor 114) to assess the quality of the loan. An owner of a loan (e.g., the lender 108) may enable or disable another party's (e.g., the closing agent 104 or the investor 114) access of loan closing data or loan analysis data through the loan analysis system 102.

For the lender 108, the loan analysis system 102 can request a loan settlement vendor, such as the closing agent 104, to capture and deliver loan closing data, such as HUD-1 data, in an industry-accepted data standard (e.g., MISMO® standard). Additionally, through the loan analysis system 102, the lender 108 can consistently apply the same level of review or assessment of a loan using a set of lender-specific analytical rules, regardless of settlement vendor providing the loan closing data.

Through an investor-specific data portal provided by the loan analysis system 102, the investor 114 can review the analysis results and score information for given a loan. The investor data portal may provide the results and score information in conjunction with HUD-1 data associated with the loan. The investor-specific data portals may further permit an investor (e.g., the investor 114) to control their data access policies and eliminate cross-ownership portal conflicts (e.g., various investors using the system to store and or to analyze their data cannot preclude additional investors from also establishing and operating similar system instances on the same data).

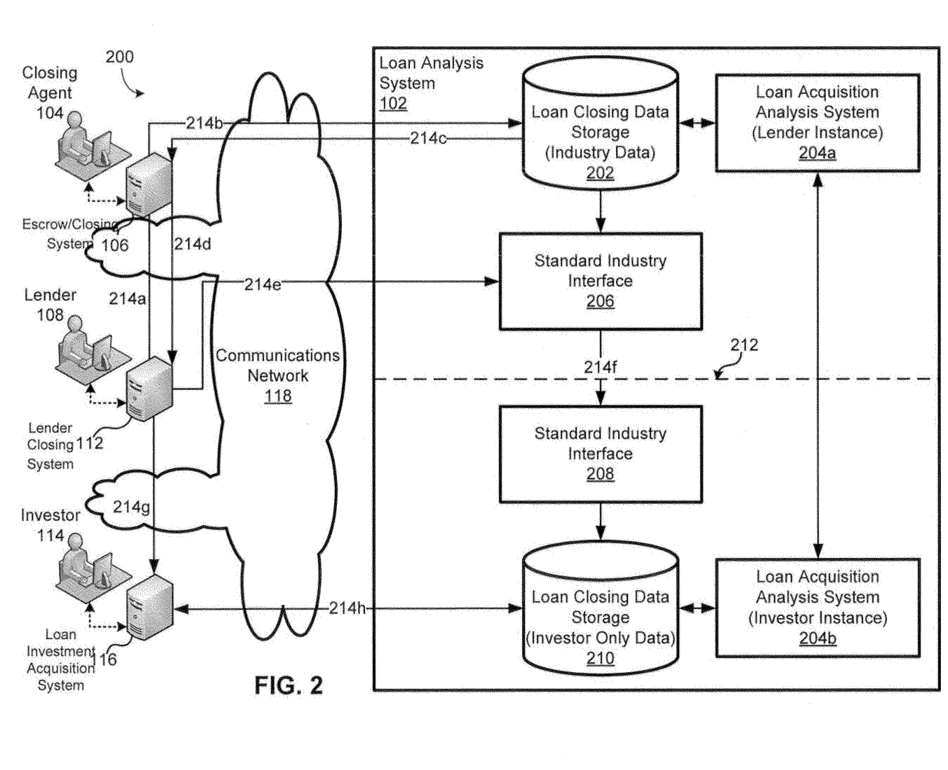

FIG. 2 is diagram illustrating data interactions between the closing system 106, the lender closing system 112, the loan investment acquisition system 116, and the loan analysis system 102, in accordance with some embodiments, in an exemplary environment 200. As shown in FIG. 2, the loan analysis system 102 may comprise a loan closing data storage 202, a loan acquisition analysis system 204a, and a standard industry interface 206 (e.g., MISMO® standard) configured for data interaction with the closing system 106 and the lender closing system 112, and a separate a standard industry interface 208, loan closing data storage 210, and loan acquisition system 204b for data interaction with the loan investment acquisition system 116.

In some embodiments, the loan closing data storage 202, the loan acquisition analysis system 204a, and the standard industry interface 206 may be segregated from the standard industry interface 208, the loan closing data storage 210, and the loan acquisition system 204b, possibly by a security access control mechanism 212, configured to limit data access over the mechanism 212. With the segregation of data access, certain embodiments can further ensure various parties only have access to data intended for their access (e.g., investors only have access to investor-specific analysis results).

In accordance with FIG. 2, the process of analyzing a loan may begin with step 214a, where the lender 108 orders the closing agent 104 to close the loan and sends loan information needed for closing the loan to the closing agent 104. The lender 108 may utilize the lender closing system 112 to order the closing agent 104 to close the loan and send the loan information to the closing agent 104. The closing agent 104 may receive the order and the loan information via the closing system 106.

At step 214b, the closing agent 104 may on behalf of the lender 108, submit the loan closing data (e.g., including HUD-1 data) to the loan analysis system 102 via the closing system 106. The loan analysis system 102 may store the received loan closing data in the loan closing data store 202. Subsequently, from the loan closing data store 202, the loan acquisition analysis system 204a (for the lender) can retrieve the loan closing data and analyze a loan based on the retrieved loan closing data. Optionally, the analysis results generated by the loan acquisition analysis system 204a may be stored on the loan closing data store 202 for later retrieval and review by the lender 108 or the closing agent 104.

To enable investor access to certain loan data and loan closing data, at step 214c the closing agent 104 may receive (e.g., via the closing system 106) a loan closing data (e.g., HUD-1 data) identifier (e.g., a Uniform Loan Delivery Dataset [ULDD] compliant identifier) associated with the loan closing data submitted by the closing agent 104 during step 214b. At step 214d, this loan closing data identifier may be provided by the closing agent 104 (e.g., using the closing system 106) to the lender 108. Once the lender 108 receives the loan closing data identifier (e.g., at the lender closing system 112), at step 214e the lender 108 can request the loan analysis system 102 assign or grant access to the loan closing data (or to loan analysis result generated by the loan acquisition system 204a based on the loan closing data) to an investor (actual or potential) using the loan closing data identifier received step 214d. In some embodiments, the lender 108 can request the assignment or access grant via the standard industry interface 206 of the loan analysis system 102. In such embodiments, the assignment or access grant may permit the standard industry interface 206 (at step 214f) to deliver loan closing data (or loan analysis results) from the loan closing data storage 202 to the loan closing data storage 210 through the standard industry interface 208. Additionally, the lender 108 (e.g., via the lender closing system 112) can provide the investor 114 with the loan closing data identifier at step 214g. For some embodiments, each investor may be provided access to their own loan closing data (e.g., HUD-1 data) repository, which may become automatically populated when the lender 106 assigns a loan to the investor.

With the loan closing data identifier, the investor 114 can access the loan closing data, via the loan investment acquisition system 116, at step 215h. Additionally, with the loan closing data identifier, the investor 114 can request the loan acquisition analysis system 204b (for the investor) to analyze a loan, based on the loan closing data, based on investor-specific rules.

As noted herein, the loan data and the loan closing data described herein may be formatted in accordance with industry data standards, such as MISMO®, to ensure wider compatibility with various systems in the industry. Subsequent descriptions of the loan acquisition analysis systems 204a and 204b will hereafter be referred to as the loan acquisition analysis system 204.

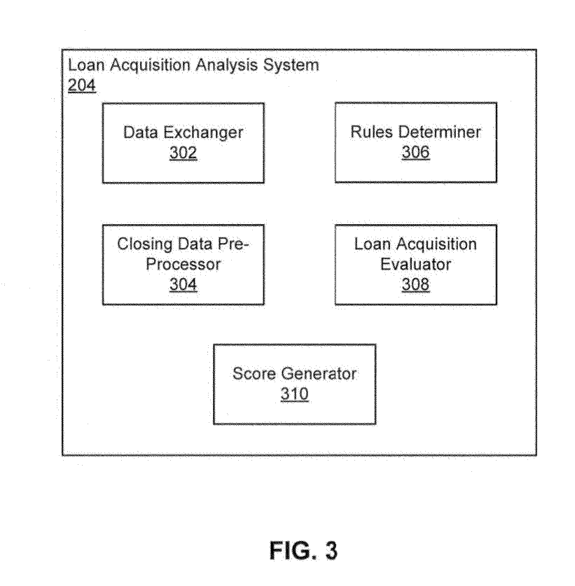

FIG. 3 is diagram illustrating an exemplary loan acquisition analysis system 204 in accordance with some embodiments. Referring now to FIG. 3, the loan acquisition analysis system 204 comprises a data exchanger 302, a closing data pre processor 304, a rules determiner 306, a loan acquisition evaluator 308, and a score generator 310.

The data exchanger 302 may be configured to receive or transmit data for the loan acquisition analysis system 204. For example, the data exchanger 302 may be responsible for receiving loan closing data, such as HUD-1 data, from a closing system (being operated by a closing agent). In some embodiments, the data exchanger 302 may implement industry data standards (e.g., MISMO®) to better facilitate industry-wide system compatibility with other industry-related systems (e.g., escrow systems or lending systems). Where the data exchanger 302 receives electronic loan documents (e.g., PDFs) or outputs electronic documents (e.g., PDF report of loan analysis results), the data exchanger 302 may be configured to format such documents as necessary for processing (e.g., optical character recognition [OCR]).

The closing data pre-processor 304 may be configured to prepare interim analysis results from the loan closing data received through the data exchanger 302. Depending on the embodiment, the interim analysis result may comprise data extracted from loan closing data, such as the HUD-1 form. The interim analysis result may further comprise values calculated based on the loan closing data or validation information relating to the loan closing data. Additionally, the interim analysis result may comprise analytical rule selections based on the loan closing data received. For example, based on pre-processing of the loan closing data, the closing data pre-processor 304 may enable or disable rule selections to be applied by the loan acquisition evaluator 308.

The rules determiner 306 may be configured to determine the set of analytical rules to be utilized by the loan acquisition evaluator 308 during analysis of the loan closing data. For instance, where the party requesting the analysis is an investor, a set of investor-specific rules and a set of investor standard rules may be applied to the loan closing data by the loan acquisition evaluator 308.

For some embodiments, the analytical rules may be generally configured to performance compliance of loan closing data. For example, particular rules may be configured to check compliance with respect to completeness of the loan closing data, with respect to conditions/equations (e.g., logic) applied to the loan closing data, or with respect to federal or state regulations. The rules may be configured to check loan closing data based on compliance or risk categories, where the analysis results can be grouped into categories, and each of the categories can be scored. The compliance or risk categories can be customized by parties to meet their analytical needs. Particular embodiments may permit a lender or investor to view analytics of a loan based on application of calculable rules, which may be deployed to trading desk (e.g., loan investment systems) and which can be captured in a system-analyzable format.

Analytical rules may involve maintenance and updates on a periodic, scheduled, or real-time/on-time basis, depending on what the analytical rule embodies. For instance, where an analytical rule is based on federal or state regulation (e.g., high cost limit regulation-based rules), updates to the regulations can be reflected as changes to the affected analytical rules. In some embodiments, the systems and methods utilize a rule format flexible enough to accommodate updates with minimal resources or minimal effort. A standard maintenance program may involve a proactive approach to investor and regulatory changes that impact rules, 30 day notifications for upcoming changes to standard rule sets, and a standard evaluation and change process for rules. Under a customer maintenance program, an analytical rule can be updated a party's discretion (e.g., lender or investor discretion), 30 days after written change request, and activating rules on specific dates.

Depend on the embodiments, standard rules set may include one or more the rules provided in the following Table 1. For each rule, the Table 1 provides a brief description of each rule, and the potential ramification addressed by the rule with a respect to a given loan.

| Rule Categories | Description | Potential Ramification |
|---|---|---|
| Minimum Borrower | Detects whether a minimum down | Loan not eligible for |
| Contribution | payment has not been met on a | investor delivery. |
| | purchased loan. The minimum down | |
| | payment can be described as a | |
| | percentage that is generally required to | |
| | be paid toward the down payment, | |
| | closing costs, and financial reserves. | |
| | The contribution may be required from | |
| | the borrower's own funds or in some | |
| | cases from other eligible sources of | |
| | funds. | |
| Excessive | Detects non-allowable contributions | Loan not eligible for |
| Contributions from | and concessions on purchase loans. | investor delivery. |
| Interested Parties | Describes costs that are normally the | |
| | responsibility of the property purchaser | |
| | that are paid (directly or indirectly) by | |
| | someone else who has a financial | |
| | interest in, or can influence the terms | |
| | and the sale or transfer of, the subject | |
| | property. These persons or entities | |
| | include, but are not limited to, the | |
| | property seller, the builder/developer, | |
| | and the real estate agent or broker (or | |
| | an affiliate who may benefit from the | |
| | sale of the property and/or the sale of | |
| | the property at the highest price | |
| | possible). | |
| Refinance Cash-Out | Detects when cash out amount exceeds | Warrants loan-level price |
| Limitations | limits of investor refinance products. A | adjustment. |
| | Limited Cash-out Refinance (“Limited | |
| | Cash Refi”) is a refinance transaction in | |
| | which the mortgage amount generally | |
| | is limited to the sum of the unpaid | |
| | principal balance of the existing first | |
| | mortgage, closing costs (including | |
| | prepaid items), points, and the amount | |
| | required to satisfy any mortgage liens if | |
| | the documented proceeds of the | |
| | subordinate financing were solely used | |
| | to acquire the property (if the borrower | |
| | chooses to satisfy them), and other | |
| | funds for the borrower's use (e.g., as | |
| | long as the amount does not exceed the | |
| | lesser of $2,000 or 2% of the principal | |
| | amount of the new mortgage). | |
| CLTV Check on | Detects when combined loan-to-value | Warrants loan-level price |
| Simultaneous Seconds | of concurrent loans exceeds investor | adjustment. |
| | limits. A new second mortgage | |
| | originated at the same time as a | |
| | purchase or refinance, with a lien | |
| | position subordinate to the first | |
| | mortgage (also called a “piggyback,”) | |
| | may be shown on the same HUD-1 as | |
| | the first mortgage or on a second, | |
| | separate HUD-1. Loans with | |
| | simultaneous seconds pay a loan-level | |
| | price adjustment due to the risk of a | |
| | higher CLTV (combined loan-to-value) | |
| | ratio. | |
| Loan Originator | Detects when points and fees exceed | Loan not eligible for |
| Compensation | investor limits. The fee(s) charged by a | investor delivery. |
| | lender to prepare loan documents, make | |
| | credit checks, inspect, and sometimes | |
| | appraise a property. The fee(s) are | |
| | usually computed as a percentage of the | |
| | face value of the mortgage. For | |
| | example, certain investors will not | |
| | purchase or securitize mortgages if the | |
| | total points and fees charged to the | |
| | borrower exceed the greater of 5% of | |
| | the mortgage amount or $1,000 | |
| | regardless of the party paying the fee. | |
| Potential Mortgage | Detects indicators of potential fraud for | Loan risks immediate |
| Fraud | profit schemes. Certain investors will | repurchase from investor. |
| | require the immediate repurchase of a | |
| | mortgage loan, or of an acquired | |
| | property, if the lender breaches any | |
| | selling warranty - including instances | |
| | of fraud. Though fraud can be difficult | |
| | to conclude solely through data | |
| | evaluation, HUD-1 data may be able to | |
| | warn of potential risk for further | |
| | determination by lender. | |
| Exceptional Line | Identifies abnormal patterns of usage | Loan potentially has |
| Activity | on the HUD-1. Research has detected a | serious issues. |
| | strong correlation between the number | |
| | of lines used on the HUD-1 and the | |
| | likelihood of loan quality issues. When | |
| | “filled” lines of the HUD-1 are | |
| | evaluated, approximately 3.2% exceed | |
| | the norm and may require an escalated | |
| | review by the lender. When “free- | |
| | form” lines of the HUD-1 are | |
| | evaluated, approximately 1.7% exceeds | |
| | the norm and may require an escalated | |
| | review by the lender. | |
| HOEPA-Section 32 or | Detects when specific fees exceed | Loan risks immediate |
| State-specific High | federal and state regulatory limits. A | repurchase from investor. |
| Fees Test | mortgage loan that is subject to the | |
| | Home Ownership and Equity | |
| | Protection Act of 1994 (HOEPA), as | |
| | described in Section 32 of Regulation | |
| | Z, is not eligible for delivery to certain | |
| | investors. Evaluating the “Points and | |
| | Fees Test” for what borrowers pay at or | |
| | before closing to qualify as a “Section | |
| | 32” mortgage. These costs typically are | |
| | paid out of the loan proceeds but could | |
| | be prepaid POC charges. Regardless of | |
| | what the fee is called, if it goes directly | |
| | to the lender or broker, Regulation Z | |
| | likely considers it a prepaid finance | |
| | charge. In addition, certain investors | |
| | do not purchase or securitize mortgage | |
| | loans that meet the definitions under | |
| | specific laws of the state in which the | |
| | property is located (“higher-priced | |
| | loans”), regardless of whether any | |
| | provision of such state law is | |
| | preempted by federal law with respect | |
| | to a particular loan or for a particular | |
| | originator. | |
| Line Amount Checks | Compares intra-document data for | |
| & Balances | consistency and accuracy. | |
| Third-Party Fees by | Detects when required state fees are not | |
| State | present on the HUD-1. This rule | |
| | focuses on third-party fees that may not | |
| | be allowed on the HUD-1 Statement in | |
| | certain states. | |

As an example of loan closing data evaluated by analytical rules, evaluation logic contained in analytical rules, and closing data preprocessed in accordance with analytical rules, we take for consideration the exemplary rule “Minimum Borrower Contribution.”

The “Minimum Borrower Contribution” rule may consider the following fields from HUD-1 form (OMB Approval No. 2502-0265): 201. Deposit or earnest money; 202. Principal amount of new loan(s); 303. Cash (X From) (To) Borrower; and 401. Contract sales price. Additional loan closing data considered by the “Minimum Borrower Contribution” rule may include Loan-to-value (LTV) ratio, transaction type (e.g., refinance, purchase, construction, equity, HELOC, or reverse), occupancy type (e.g., principal residence, second home, or investment), special investor product, source of funds (e.g., borrower, personal gifts, donations, or disaster relief, employer assistance, or community seconds), and number of units, high cost area (HCA) loan limits table.

The preprocessing of loan closing data required by the “Minimum Borrower Contribution” rule may include the following logic.
(Logic 1) If Transaction=“Purchase” and Appraised Value<=Line 401, then LTV=Line 202/Appraised Value or if Transaction=“Purchase” and Line 401<Appraised Value, then LTV=Line 202/Line 401
(Logic 2) If Line303ToBorrower=“To” then Line303ToBorrower.Actual=HUD.LineActual(303) and Line303FromBorrower.Actual=0 or if Line303ToBorrower=“From” then Line303FromBorrower.Actual=HUD.LineActual(303) and Line303ToBorrower.Actual=0

The evaluation logic of the “Minimum Borrower Contribution” rule may include the following.
(Logic 3) Transaction=“Purchase and LTV>95% and sum ((Lines 201+Line 303From)−Line 303To)<=$500
(Logic 4) Transaction=“Purchase” and LTV>90% and sum ((Lines 201+Line 303From)−Line 303To)<5% of Line 401
(Logic 5) Transaction=“Purchase and LTV>80% and Source≠“Disaster Relief” and Line 202>HCA Loan Limit* and Special=“MyCommunityMortgage®” and sum ((Lines 201+Line 303From)−Line 303To)<3% of Line 401
(Logic 6) Transaction=“Purchase” and LTV>80% and Source≠“Disaster Relief” and Line 202>HCA Loan Limit* and Special=“None” and sum ((Lines 201+Line 303From)−Line 303To)<5% of Line 401
(Logic 7) Transaction=“Purchase” and LTV>80% and Source≠“Borrower” and Units>1 or Occupancy=“Second Home” and Special=“MyCommunityMortgage®” and sum ((Lines 201+Line 303From)−Line 303To)<3% of Line 401
(Logic 8) Transaction=“Purchase and LTV>80% and Source≠“Borrower” and Units>1 or Occupancy=“Second Home” and Special=“None” and sum ((Lines 201+Line 303From)−Line 303To)<5% of Line 401
(Logic 9) Transaction=“Purchase and Source=“Personal Gifts” and Occupancy=“Investment”
(Logic 10) Transaction=“Purchase and Source=“Donation or “Employer Assistance” and Occupancy=“Second Home” or “Investment”

Those skilled in the art would appreciate that the exemplary analytical rules described herein, and those customized by individual parties (e.g., lenders or investors) may be configured in a manner similar to that of the exemplary “Minimum Borrower Contribution” rule described above. Additionally, in various embodiments, a lender may enable or disable which analytical rules will he included in a standard rule set to he applied in the analysis of a loan.

Continuing with reference to FIG. 3, the loan acquisition evaluator 308 may he configured to use analytical rules to analyze loan closing data (e.g., HUD-1 data) to assess the quality and repurchase risk of a loan associated with the loan closing data. In some embodiments, the analytical rule may comprise logic utilized by the loan acquisition evaluator 308 in analyzing the loan closing data. As noted herein, the analytical rule may also identify the data in the loan closing data utilized by the evaluation logic.

The score generator 310 may be configured to receive the analysis results from the loan acquisition evaluator 308 and generate a set of scores based on the analysis results. In some embodiments, the set of scores may include a score that corresponds with each analytical rule applied to the loan closing data or with each compliance/risk category. The score generator 310 may be configured to generate an overall score for a loan based on the analysis results or the set of scores. In various implementations, the score may optional or customizable by the party requesting the loan analysis (e.g., lender or investor). As scoring, embodiments may associate each rule with a designated score, weight or indicator (e.g., a visual indicator, such as color) based on the analysis results from the loan acquisition evaluator 308. For example, a scoring scheme may utilize red, yellow, and green visual indicators. In such an example, a red score may indicate one or more known errors (e.g., violations of analytical rules or failure to meet analytical rule conditions) with high repurchase risk if unresolved and may recommend further quality review by the requesting party. The yellow score may indicate one or more suspected errors that could result in repurchase and may suggest further quality review by the requesting party. The green score may indicate no indication of repurchase risk based on the loan closing data analyzed.

Further, in some embodiments, the score generator 310 may be configured to score in alignment with each stakeholder's/party's respective quality review standard (e.g., a lender's standard of review or an investor's standard of review) and resolution process. As such, for some embodiments, the severity of the scoring for each analytical rule or category of analysis may be customizable by the parties using the embodiments. For instance, for one particular lender the score generator 310 may be configured such that a yellow scoring is generated to indicate that the loan is subject to further review by a supervisor with no delay to the closing process, while a red scoring is generated to indicate a full stop of the closing process until a quality issue identified (e.g., in accordance with the lender's analytical rules) is resolved or overridden by an authorized officer. Scoring by the score generator 310 may be determined for a party (e.g., lender or investor) during an analytical rule-implementation process, and may be modified/adjusted (e.g., manually or automatically) over time to align with changes to the party's quality review standard and resolution process. Various embodiments may permit a party to select and customize scoring categories (e.g., category names, weights, etc.) such that the categories better align with the party's internal operations. Scoring generated by the score generator 310 may be expressed as text indicators (“Further Review/Warning Flags/No issues”), percentages, numeric scoring, or other method as requested by the lender or investor.

It will be appreciated by those skilled in the art that various embodiments may employ a variety of techniques when generating a set of scores based on the analysis results (including those based on equations or calculations), and may employ a variety of output techniques (e.g. visual, audio, textual, numerical, etc.) when providing the set of scores to a party. The techniques employed may be in accordance with the set of analytical rules associated with the party.

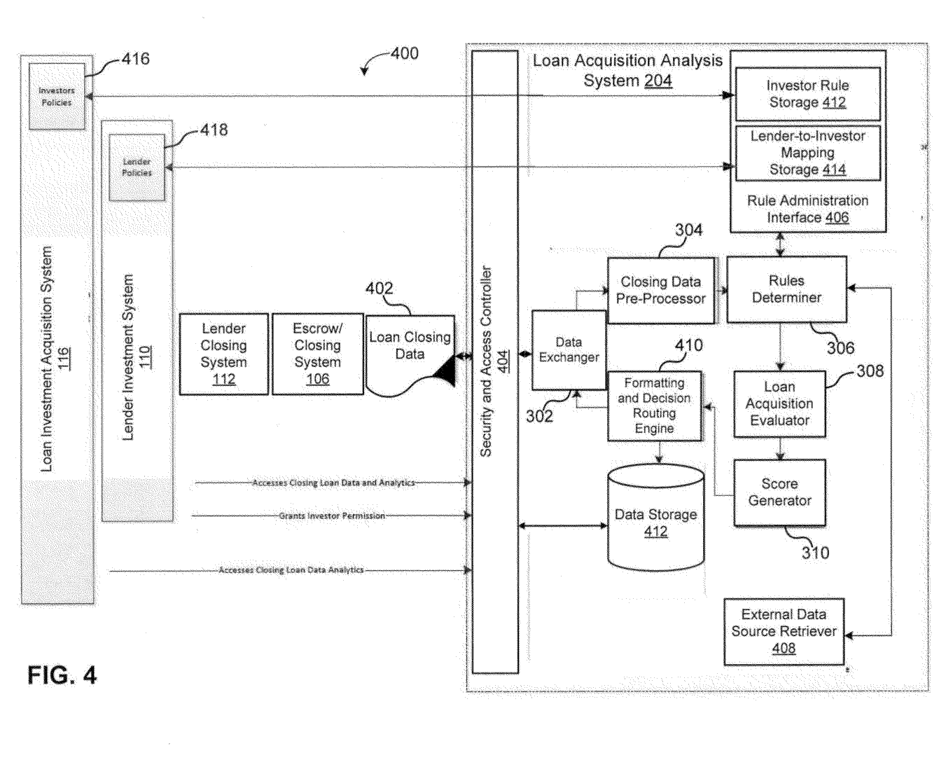

FIG. 4 is a diagram illustrating data interactions between the loan investment acquisition system 116, the lender investment system 110, the lender closing system 112, the closing system 106, and the loan acquisition analysis system 204, in an exemplary environment 400, in accordance with some embodiments. In accordance with the embodiment illustrated in FIG. 1, the loan investment acquisition system 116, the lender investment system 110, the lender closing system 112, the closing system 106, and the loan acquisition analysis system 204 (e.g., as part of the loan analysis system 102) may be communicatively coupled with each other through a computer network (e.g., a wired or wireless network connection), thereby facilitating data interactions between the systems 106, 110, 112, 116, and 204 through one or more network systems.

As described herein with reference to FIG. 3, the loan acquisition analysis system 204 comprises the data exchanger 302, the closing data pre-processor 304, the rules determiner 306, the loan acquisition evaluator 308, and the score generator 310. As additionally shown in FIG. 4, the loan acquisition analysis system 204 may further comprise a security and access controller 404, a rule administration interface 406, an external data source retriever 408, a formatting and decisions routing engine 410, and a data storage 412.

As noted with reference to FIG. 3, the data exchanger 302 may be configured to receive or transmit data for the loan acquisition analysis system 204, the closing data pre-processor 304 may be configured to prepare interim analysis results from the loan closing data received through the data exchanger 302, the rules determiner 306 may be configured to determine the set of analytical rules to be utilized by the loan acquisition evaluator 308 during analysis of the loan closing data, the loan acquisition evaluator 308 may be configured to use analytical rules (e.g., determined by the rules determiner 308) to analyze loan closing data (e.g., HUD-1 data) to assess the quality and repurchase risk of a loan associated with the loan closing data, and the score generator 310 may be configured to receive the analysis results from the loan acquisition evaluator 308 and generate a set of scores based on the analysis results.

In accordance with FIG. 4, the loan acquisition analysis system 204 may receive loan closing data 402 from the closing system 106, through the security and access controller 404. The security and access controller 404, for some embodiments, controls access to data input to and output from the loan acquisition analysis system 204. One the loan closing data 402 is permitted through the security and access controller 404, it may be received by the data exchanger 302 of the loan acquisition analysis system 204. After the closing data pre-processor 304 generates interim analysis results from the received loan closing data, the rules determiner 306 may determine the set of analytical rules from the rule administration interface 406.

Depending on the embodiments, the rule administration interface 406 may be configured to provide storage of standard and custom analytical rules sets, and to provide an interface (e.g., web-based GUI) by which interested parties (e.g., lenders or investors) can select what rules they wish to apply, select analytical rule preferences, and permit a party to create custom rules on or send custom rule to the loan acquisition analysis system 204. For example, in FIG. 4, the loan investment acquisition system 116 may provide investor policies 416, which may include investor-specific analytical rules, to the loan acquisition analysis system 204 through the rule administration interface 406. Likewise, the lender investment system 110 may provide lender policies 418, which may include lender-specific analytical rules, to the loan acquisition analysis system 204 through the rule administration interface 406. Once received by the rule administration interface 406, the interface 406 may store the policies and rules appropriately.

As further illustrated by FIG. 4, the rule administration interface 406 may comprise an investor rule storage 412 configured to store investor-specific rules for a variety of different investors, and a lender-to-investor mapping storage 414 configured to store a lender-specific relationships with investors and lender's preferences with respect to those investors. The rule administration interface 406 may further facilitate maintenance of analytical rules, as described herein.

In some embodiments, the rules determiner 306 may select or deter mine the set of analytical rules based on information retrieved from a data source external to the system (e.g., data source maintained by a third party). For example, the rule determiner 306 may be configured to instruct the external data source retriever 307 to request and retrieve additional data from data sources external to the system 204, including publicly-available government databases and commercially-available databases.

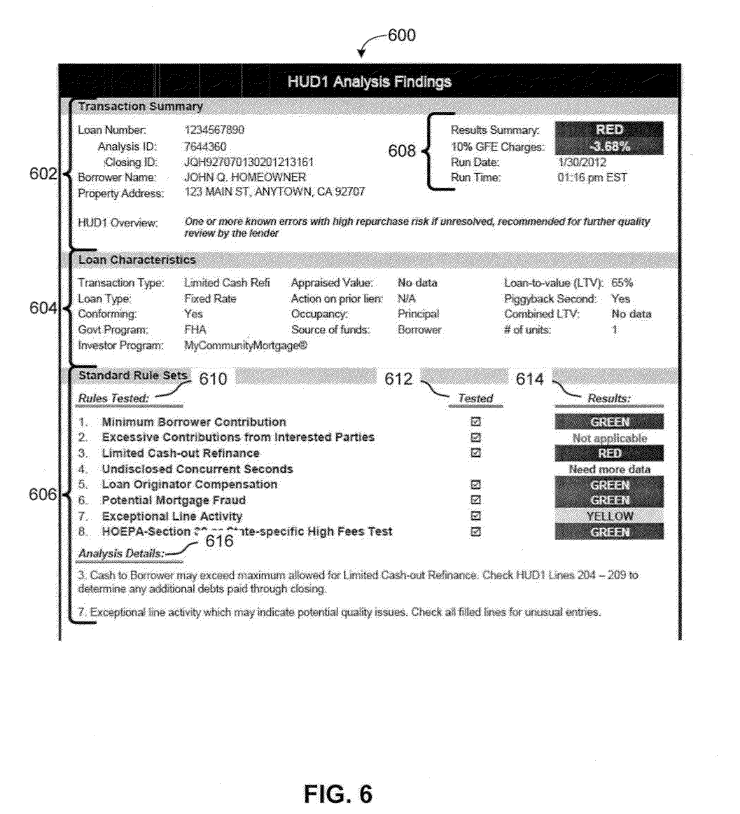

Following the generation of a score by the score generator 310, the score or the analysis results may be provided to the formatting and decision routing engine 410 for appropriate handling. In some instances, the formatting and decision routing engine 410 may prepare the results for a report (such as the report described in FIG. 6), a structured file in compliance with an industry data standard (e.g., MISMO®), or for storage in the data storage 412 of the loan acquisition analysis system 204.

In various embodiments, a lender may employ the lender investment system 110 in granting an investor access to loan closing data or loan analytical results stored on the loan acquisition analysis system 204. Based on the permission granted, an investor may be capable of reviewing the loan closing data from the loan acquisition analysis system 204 through the loan investment acquisition system 116, and may be also capable of requesting analysis of the loan closing data to assess the quality of the underlying loan. It should be appreciated by those skilled in the art that the lender investment system 110 and the loan investment acquisition system 116 are merely generic names used to describe software or hardware utilized by lenders and investors respectively to perform operations in conjunction with embodiments described herein. For instance, the functions of the lender investment system 110 or the loan investment acquisition system 116 may be implemented in trading desk software configured to handle trading/sales of loans and access to loan related data.

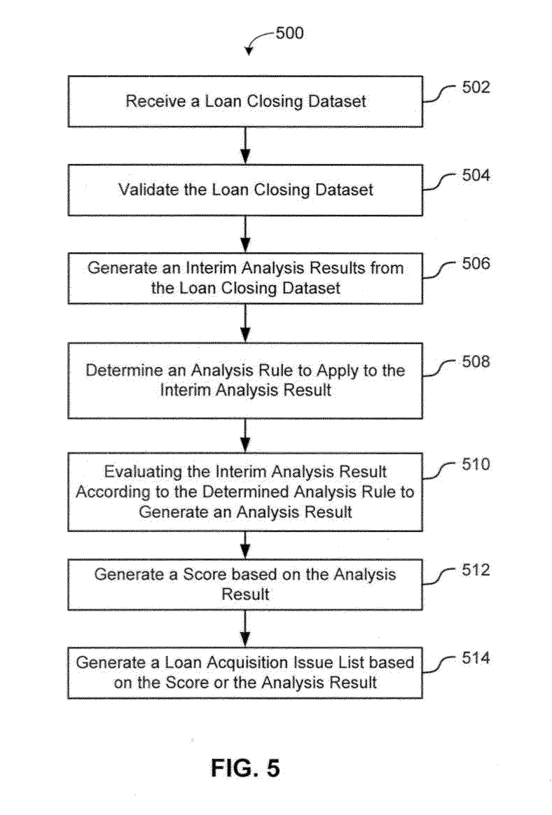

FIG. 5 is flowchart 500 illustrating an exemplary method for analyzing loan acquisitions in accordance with some embodiments. As shown by flowchart 500, the method may begin at operation 502 by receiving a loan closing dataset, relating to a loan, from a closing agent. The loan closing dataset may, in some embodiments, comprise HUD-1 data, title information, and other loan related information useful in the loan closing processes.

At operation 504, the loan closing dataset may be validated before loan analysis can continue. In some embodiments, the loan closing dataset may be validated to ensure appropriate loan closing data is utilized during the loan analysis process.

At operation 506, interim analysis results are generated from the loan closing dataset. As noted herein, the interim analysis results may comprise particular data gathered/extracted from the loan closing data received at operation 502.

Next, at operation 508, an analysis rule determined for application to the interim analysis results. As discussed herein, the analysis rules determined (e.g., selected) for application may be based on whom is requesting the loan analysis and the settings of the system.

Subsequently, at operation 510, the interim analysis results are evaluated according to the analysis rules determined in operation 508. The evaluation may be according to the logic provided in the determined analysis rules.

At operation 512, a score is generated based on the analysis result generated at operation 510. The method may further continue by generating a loan acquisition issue list based on the score generated at operation 512 or the analysis result generated at operation 510.

FIG. 6 is an exemplary analysis report 600 generated by some embodiments. As shown, the analysis report 600 may comprise a loan and real estate transaction summary section 602, a loan characteristics section 604, and the analytical rules section 606.

In the loan and real estate transaction summary section 602, the report 600 may provide a loan number, a loan analysis ID (e.g., to identify a specific iteration of analysis of the loan identified by the loan number), a closing ID (e.g., which corresponds to the identifier used by the closing agent to identify the loan closing data on a closing system), a lendee/borrower name, or an address to real property associated with the loan identified by the loan number. The loan and real estate transaction summary section 602 may further provide a summary 608 of the analysis results and an overall score (e.g., red score).

In the loan characteristics section 604, the report 600 may list the transaction type, loan type, conformity of the loan, government program relating to the loan analyzed, investor program relating to the loan analyzed, occupancy of the loan, the LTV, indication of a piggyback second, or number units of the real estate relating to the loan.

In the analytical rules section 606, the report 600 may provide a listing 610 of analytical rules that can be applied during loan analysis, a listing 612 of whether the analytical rules have been applied, or a listing 614 of results of applying the analytical rules. As shown in FIG. 6, the listing 614 may provide results for each analytical rule applied using a color score (e.g., green, yellow, or red) where applicable. In addition to results of the analytical rules, the analytical rules section 606 can provide analysis details 616 regarding application of the analytical rules to the loan closing data.

As used herein, the term set may refer to any collection of elements, whether finite or infinite. The term subset may refer to any collection of elements, wherein the elements are taken from a parent set; a subset may be the entire parent set. The term proper subset refers to a subset containing fewer elements than the parent set. The term sequence may refer to an ordered set or subset. The terms less than, less than or equal to, greater than, and greater than or equal to, may be used herein to describe the relations between various objects or members of ordered sets or sequences; these terms will be understood to refer to any appropriate ordering relation applicable to the objects being ordered.

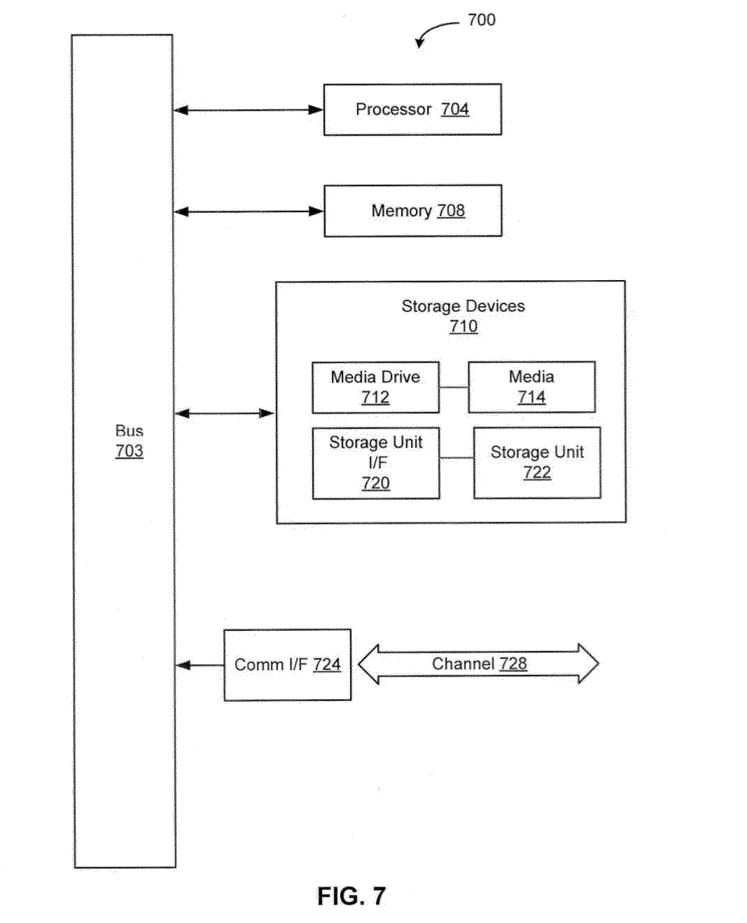

As used herein, various system components described herein might describe a given unit of functionality that can be performed in accordance with one or more embodiments. As used herein, the system components may be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various system components described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared system components in various combinations and permutations. Even though various features or elements of functionality may be individually described or claimed as separate system components, one of ordinary skill in the art will understand that these features and functionality can be shared among one or more common software and hardware elements, and such description shall not require or imply that separate hardware or software components are used to implement such features or functionality.

Where embodiments are implemented in whole or in part using software, these software elements may be implemented to operate with a computing or processing device or system capable of carrying out the functionality described with respect thereto. One such example computing system is shown in FIG. 7. Various embodiments are described in terms of this example-computing system 700. After reading this description, it will become apparent to a person skilled in the relevant art how to implement the invention using other computing modules or architectures.

Referring now to FIG. 7, computing system 700 may represent, for example, computing or processing capabilities found within desktop, laptop and notebook computers; hand-held computing devices (PDA's, smart phones, cell phones, palmtops, etc.); mainframes, supercomputers, workstations or servers; or any other type of special-purpose or general-purpose computing devices as may be desirable or appropriate for a given application or environment. In some embodiments, the computing system 700 may be a virtual computer system (e.g., cloud-based computing resource) that operates on and is provided by one or more servers over a network. The computing system 700 might also represent computing capabilities embedded within or otherwise available to a given device. For example, a computing system might be found in other electronic devices such as, for example, digital cameras, navigation systems, cellular telephones, portable computing devices, modems, routers, WAPs, terminals and other electronic devices that might include some form of processing capability.

The computing system 700 might include, for example, one or more processors, controllers, control modules, or other processing devices, such as a processor 704. The processor 704 might be implemented using a general-purpose or special-purpose processing engine such as, for example, a microprocessor, controller, or other control logic. In the illustrated example, the processor 704 is connected to a bus 702, although any communication medium can be used to facilitate interaction with other components of computing system 700 or to communicate externally.

The computing system 700 might also include one or more memory modules, simply referred to herein as main memory 708. For example, preferably random access memory (RAM) or other dynamic memory, might be used for storing information and instructions to be executed by the processor 704. The main memory 708 might also be used for storing temporary variables or other intermediate information during execution of instructions to be executed by the processor 704. The computing system 700 might likewise include a read only memory (“ROM”) or other static storage device coupled to the bus 702 for storing static information and instructions for the processor 704.

The computing system 700 might also include one or more various forms of information storage mechanism 710, which might include, for example, a media drive 712 and a storage unit interface 720. The media drive 712 might include a drive or other mechanism to support fixed or removable storage media 714. For example, a hard disk drive, a floppy disk drive, a magnetic tape drive, an optical disk drive, a CD or DVD drive (R or RW), or other removable or fixed media drive might be provided. Accordingly, the storage media 714 might include, for example, a hard disk, a floppy disk, magnetic tape, cartridge, optical disk, a CD or DVD, or other fixed or removable medium that is read by, written to or accessed by media drive 712. As these examples illustrate, the storage media 714 can include a computer readable storage medium having stored therein computer software or data.

In alternative embodiments, information storage mechanism 710 might include other similar instrumentalities for allowing computer programs or other instructions or data to be loaded into computing system 700. Such instrumentalities might include, for example, a fixed or removable storage unit 722 and an interface 720. Examples of such storage units 722 and interfaces 720 can include a program cartridge and cartridge interface, a removable memory (for example, a flash memory or other removable memory module) and memory slot, a PCMCIA slot and card, and other fixed or removable storage units 722 and interfaces 720 that allow software and data to be transferred from the storage unit 722 to computing system 700.

The computing system 700 might also include a communications interface 724. Communications interface 724 might be used to allow software and data to be transferred between computing system 700 and external devices. Examples of communications interface 724 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 724 might typically be carried on signals, which can be electronic, electromagnetic (which includes optical) or other signals capable of being exchanged by a given communications interface 724. These signals might be provided to communications interface 724 via a channel 728. This channel 728 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer readable medium,” “computer program medium,” and “computer usable medium” are used to generally refer to media such as, for example, the memory 708, the storage unit 720, the media 714, and the channel 728. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing system 700 to perform features or functions of the present invention as discussed herein.

While various embodiments of the present invention have been described above, it should be understood that they have been presented by way of example only, and not of limitation. Likewise, the various diagrams may depict an example architectural or other configuration for the invention, which is done to aid in understanding the features and functionality that can he included in the invention. The invention is not restricted to the illustrated example architectures or configurations, but the desired features can be implemented using a variety of alternative architectures and configurations. Indeed, it will he apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module arc all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A non-transitory computer readable medium comprising executable instructions, the executable instructions being executable by a processor in a computing device to perform a method for analyzing loan acquisitions, the method comprising:
receiving a loan closing dataset relating to a loan at a computer system;
generating, at the computer system, a set of interim analysis results from the loan closing dataset by extracting information from the loan closing dataset;
evaluating, at the computer system, the set of interim analysis results according to a set of analysis rules to generate a set of analysis results, wherein the set of analysis rules are configured to evaluate a transfer of interest in the loan for a set of investment risks; and
generating, at the computer system, a set of scores for the loan based on the set of analysis results, wherein the set of scores are representative of the set of investment risks.

2. The method of claim 1, wherein the transfer of interest is from a lender originating the loan to a party investing in the loan.

3. The method of claim 1, wherein the loan closing dataset comprises a HUD-1 settlement statement prepared in relation to the loan.

4. The method of claim 3, wherein the HUD-1 settlement statement is a final version of the HUD-1 settlement statement prepared at or near a time when a closing process for the loan concludes.

5. The method of claim 3, wherein generating a set of interim analysis results from the loan closing dataset comprises gathering information from a predetermined set of fields in the HUD-1 settlement statement.

6. The method of claim 1, wherein generating a set of interim analysis results from the loan closing dataset comprises calculating values based on the information according to the set of analysis rules.

7. The method of claim 1, wherein generating a set of interim analysis results from the loan closing dataset comprises adjusting how, during generation of the set of analysis results, the set of interim analysis results is evaluated according to the set of analysis results.

8. The method of claim 1, the method further comprising validating, at the computer system, the loan closing dataset before the set of interim analysis results is generated.

9. The method of claim 1, wherein the set of analysis rules comprises logic for evaluating the interim analysis results according to a set of investment criteria and generating a set of evaluation results that become part of the analysis results.

10. The method of claim 1, wherein the set of scores is generated according to the set of analysis rules.

11. The method of claim 10, wherein the set of analysis rules comprises logic for scoring the loan based on the set of analysis results.

12. The method of claim 10, further comprising generating, at the computer system, a loan acquisition issue list based on the set of scores or the analysis results.

13. The method of claim 1, wherein the set of analysis rules comprises a rule relating to a minimum borrower contribution, an excessive contribution from an interested party, a refinance cash-out limitation, a combined loan-to-value (CLTV) ratio check on a simultaneous second, a loan originator compensation, a potential for mortgage fraud, exceptional line activity, a regulation-specific high fee, line amount check and balance, or a third-party fee according to a regulation.

14. The method of claim 1, further comprising determining, at the computer system, the set of rules to be utilized during evaluation of the set of interim analysis results.

15. The method of claim 1, further comprising generating, at the computer system, an overall score from the set of scores.

16. A computer program product for analyzing loan acquisitions, the computer program product comprising a non-transitory computer-readable medium in which program instructions are stored, which instructions, when read by a computer system, cause the computer system to:
receive a loan closing dataset relating to a loan;
generate a set of interim analysis results from the loan closing dataset by extracting information from the loan closing dataset;
evaluate the set of interim analysis results according to a set of analysis rules to generate a set of analysis results, wherein the set of analysis rules are configured to evaluate a transfer of interest in the loan for a set of investment risks; and
generate a set of scores for the loan based on the set of analysis results, wherein the set of scores are representative of the set of investment risks.

17. The computer program product of claim 16, wherein the transfer of interest is from a lender originating the loan to a party investing in the loan.

18. The computer program product of claim 16, wherein the loan closing dataset comprises a HUD-1 settlement statement prepared in relation to the loan.

19. The computer program product of claim 18, wherein the HUD-1 settlement statement is a final version of the HUD-1 settlement statement prepared at or near a time when a closing process for the loan concludes.

20. The computer program product of claim 18, wherein generating a set of interim analysis results from the loan closing dataset comprises gathering information from a predetermined set of fields in the HUD-1 settlement statement.

21. The computer program product of claim 16, wherein generating a set of interim analysis results from the loan closing dataset comprises calculating values based on the information according to the set of analysis rules.

22. The computer program product of claim 16, wherein generating a set of interim analysis results from the loan closing dataset comprises adjusting how, during generation of the set of analysis results, the set of interim analysis results is evaluated according to the set of analysis results.

23. The computer program product of claim 16, wherein program instructions further cause the computer system to validate the loan closing dataset before the set of interim analysis results is generated.

24. The computer program product of claim 16, wherein the set of analysis rules comprises logic for evaluating the interim analysis results according to a set of investment criteria and generating a set of evaluation results that become part of the analysis results.

25. The computer program product of claim 16, wherein the set of scores is generated according to the set of analysis rules

26. The computer program product of claim 25, wherein the set of analysis rules comprises logic for scoring the loan based on the set of analysis results.

27. The computer program product of claim 25, wherein program instructions further cause the computer system to generate a loan acquisition issue list based on the set of scores or the analysis results.

28. The computer program product of claim 16, wherein the set of analysis rules comprises a rule relating to a minimum borrower contribution, an excessive contribution from an interested party, a refinance cash-out limitation, a combined loan-to-value (CLTV) ratio check on a simultaneous second, a loan originator compensation, a potential for mortgage fraud, exceptional line activity, a regulation-specific high fee, line amount check and balance, or a third-party fee according to a regulation.

29. The computer program product of claim 16, wherein program instructions further cause the computer system to determine the set of rules to be utilized during evaluation of the set of interim analysis results.

30. The computer program product of claim 16, wherein program instructions further cause the computer system to generate an overall score from the set of scores.

31. A system for analyzing loan acquisitions, implemented on a non-transitory computer readable medium, the system comprising:
a data exchanger configured to receive a loan closing dataset relating to a loan;
a closing data preprocessor configured to generate a set of interim analysis results from the loan closing dataset by extracting information from the loan closing dataset;
a loan acquisition evaluator configured to evaluate the set of interim analysis results according to a set of analysis rules to generate a set of analysis results, wherein the set of analysis rules are configured to evaluate a transfer of interest in the loan for a set of investment risks; and
a score generator configured to generate a set of scores for the loan based on the set of analysis results, wherein the set of scores are representative of the set of investment risks.

32. The system of claim 31, further comprising a rules determiner configured to determine the set of rules to be utilized during evaluation of the set of interim analysis results.

33. The system of claim 31, wherein the score generator is further configured to generate an overall score from the set of scores.

34. The system of claim 31, wherein the data exchanger is further configured to validate the loan closing dataset before the set of interim analysis results is generated.

35. The system of claim 31, wherein the loan acquisition evaluator is further configured to generate a loan acquisition issue list based on the set of scores or the analysis results.
